(19) United States
(12) Patent Application Publication
(10) Pub. No.: US 2025/0158482 A1
(43) Pub. Date: May 15, 2025

(54) STATOR FOR AN ELECTRIC MOTOR AND SPRING ELEMENT FOR THE STATOR

(71) Applicant: Brose Fahrzeugteile SE & Co. Kommanditgesellschaft, Würzburg, Würzburg (DE)

(72) Inventors: Daniel HIRSCH, Höchberg (DE); Michael DÜNCHER, Würzburg (DE)

(21) Appl. No.: 18/839,117

(22) PCT Filed: Feb. 13, 2023
(86) PCT No.: PCT/EP2023/053513

§ 371 Date: Aug. 16, 2024

(30) Foreign Application Priority Data
Feb. 16, 2022 (DE) 10 2022 201 621.1

(51) Int. Cl. H02K 5/24; B62D 5/04

(52) U.S. Cl. CPC H02K 5/24; B62D 5/0403

(57) ABSTRACT

A stator for an electric motor has a cylindrical stator main body with radially inwardly directed stator teeth and with a number of axial slots over the circumference. Each of a number of spring elements has a spring main body that is or can be radially interlockingly inserted into a corresponding axial slot and also spring arms extending or bent out of the spring body and projecting circumferentially radially beyond the stator main body. The number of spring arms increases as an axial length of the stator main body increases, and/or a ratio between a spring width of the respective spring arm and a material thickness of the spring element or the spring main body lies between 10 and 15, preferably between 11 and 14, or further preferably at 13±0.5.

The invention relates to a stator for an electric motor, in particular for a steering motor for a motor vehicle, having a cylindrical stator main body with radially inwardly directed stator teeth and with a number of axial slots over the circumference, and a number of spring elements that are or can be inserted into the axial slots. The invention also relates to an electric motor having such a stator, which is arranged in a motor housing, and a spring element group for such a stator.

In a modern motor vehicle, electric motors are used in many ways as drives for different actuating elements. Electric motors are used, for example, as window-lift, sliding-roof or seat-adjustment drives, as steering drives, as radiator fan drives or as transmission actuators. Such electric motors must have a relatively high torque or power density and be operationally reliable even at high temperatures.

An electric motor designed as an internal-rotor motor typically comprises a stator forming the stationary motor part and a rotor forming the moving motor part. In an internal-rotor motor, the stator is usually provided with a stator yoke, on which stator teeth projecting radially toward the center or inward in the manner of a star are arranged, of which the free ends facing the rotor surrounded by the stator form the so-called pole shoe. Windings or coils are attached to the stator teeth, are wired to the stator winding and generate a magnetic field during electric-motor operation. In order to guide and intensify the magnetic field generated by the energized windings, the stator material is usually metallic, for example made of soft magnetic iron.

The stator has to be arranged in the motor housing so as to be operationally reliable and so that the motor operates with little noise, wherein both radial securing and rotational securing of the stator, which secures the stator against tangential twisting, are desired. The stator is therefore generally supported in the motor housing of the electric motor by means of additional damping or decoupling elements.

DE 10 2013 009 407 A1 discloses a stator for an electric motor, which is formed from a star-shaped stator laminated core and a cylindrical stator yoke formed from stacked ring plates, into which the star-shaped stator laminated core is inserted, wherein a number of the ring plates each have at least one bending tab on the outer circumference. The radially oriented bending tabs permit fixing with simultaneous centering and positioning of the stator in a housing. When joined, the stator rests on the housing inner wall only with contact points provided at exposed locations, which are formed by the bending tabs. If the individual ring plates are provided with notches, into which the bending tabs can be bent before or during the joining process of the stator to the housing, a space-saving structure of an electric motor with a stator inserted into its housing is additionally made possible. However, vibrations generated by the stator are not sufficiently decoupled by means of such decoupling rings, and the high requirements on structure-borne sound are not fulfilled.

A stator for an electric motor, known from DE 10 2020 206 949 A1, has a stator main body with a stator yoke as magnetic return path and with a number of stator teeth, which extend radially inward in the direction of a central stator or motor axis and end in the pole shoe. Provided on the outer circumference of the stator main body is a number of axial slots, into which spring elements are inserted radially with a form fit and project radially beyond the circumference of the stator main body. The spring element inserted into the axial slot and acting as a decoupling or damping element has a strip-like main body and a number of radially elevated spring arms projecting out of the axial slot in the radial direction.

The invention is based on the object of specifying a stator for an electric motor which is decoupled as reliably as possible with respect to a motor housing with regard to reducing structure-borne sound. Flexible adaptation to different and/or specific, in particular client-specific, requirements on the structure-borne sound is to be made possible. The invention is also based on the object of specifying a particularly suitable electric motor with such a stator in a motor housing.

Furthermore, the invention is based on the object of specifying particularly suitable spring elements or a particularly suitable spring element group for such a stator. In particular, with regard to preventing vibrations of the stator, expediently even in the region of the 10^{th} order, radial stiffness, suitably including tangential and/or azimuthal stiffness, of the spring element or the spring element group is to be taken into account, preferably also while considering the rotational speed of the electric motor and/or the axial stator length.

According to the invention, with regard to the stator, the object is achieved by the features of claim 1 and, with respect to the spring element or the spring element group, by the features of claim 9 and also, with regard to the electric motor, by the features of claim 10. Advantageous refinements and developments are the subject matter of the respective subordinate claims.

The stator for an electric motor, in particular for a steering motor of a motor vehicle, has a cylindrical stator main body with radially inwardly directed stator teeth and with a number of axial slots over the circumference, and a number of spring elements, each of which has a spring main body that is or can be inserted radially with a form fit into a corresponding axial slot, and spring arms extending or bent out of the spring main body and, in the assembled state, inserted into the corresponding axial slot, projecting circumferentially radially beyond the stator main body.

The stator main body is designed, for example, as a solid body in the so-called individual tooth design or in the star-yoke design, in which the stator teeth are inserted into a cylindrical stator yoke, for example as a star collar. The respective spring element is preferably designed as a one-piece (one-part) stamped and bent part. The respective axial slot on the stator side, into which the corresponding spring element is inserted on the yoke or return-path side by being pushed in in the axial direction, engages in a suitable way behind an undercut formed in the axial slot. For this purpose, the respective axial slot (in cross section) is dovetail-shaped or else T-shaped. It is important that the axial slot provides a radial undercut behind which the joining element or its main body engages. However, other shapes (cross-sectional shapes) of the axial slot are also conceivable.

Here and in the following text, “axial” or an “axial direction” is understood in particular as a direction parallel to (coaxial with) the axis of rotation of the electric motor, i.e. perpendicular to the front faces of the stator. In a corresponding way, here and in the following text, “radial” or a “radial direction” is understood in particular as a direction oriented perpendicularly (transversely) to the axis of rotation of the electric motor along a radius of the stator or the electric motor. Here and in the following text, “tangential” or a “tangential direction” is understood in particular as a direction along the circumference of the stator or the electric motor (circumferential direction, azimuthal direction), i.e. a direction perpendicular to the axial direction and to the radial direction.

The number of spring arms of the spring elements used is chosen as a function of the length of the stator main body (stator length) and increases with increasing stator length. Additionally or alternatively, the ratio of the spring arm width of the respective spring arm of the spring elements used to the material thickness of the spring element or the spring main body (spring element or main body thickness) is between 10 and 15, preferably between 11 and 14, further preferably 13±0.5.

In an advantageous refinement, the material thickness of the spring element or the spring main body (spring element or main body thickness) is between 0.1 mm and 0.5 mm, preferably between 0.15 mm and 0.4 mm. Further advantageously, the spring arm width of the respective spring arm of the spring element used is between 1.5 mm and 5 mm, preferably between 2 mm and 4 mm.

Particularly preferably, starting from a first axial length of the stator main body and two spring arms, the spring element used has four spring arms in the case of a (second) axial length of the stator main body (stator length) that is doubled as compared with the first axial length, and, respectively, six spring arms in the case of a (second or third) axial length of the stator main body that is three times the first axial length. In an expedient development, as the axial length of the stator main body increases by (11.5±1.5) mm, the number of spring arms of the spring element increases by a further spring arm.

In a suitable way, the spring element has a coupling spring on a narrow side of the spring main body, which projects axially out of the axial slot. Particularly expedient is a configuration in which the coupling spring adjoins the spring main body via a bending portion that is radially elevated or projects out of the plane of the spring main body, in particular is approximately S-shaped, forming a contact edge. The spring element rests with this contact edge on a front face of the stator main body, preferably in the manner of a linear contact.

The spring element group has first spring elements with two (2) spring arms extending or bent out of a spring main body for a stator having a first axial length, preferably a stator length between 18.5 mm and 26 mm. In other words, the spring elements provided for such a stator are designed with two spring arms.

The spring element group additionally has second spring elements with three (3) spring arms extending or bent out of a spring main body for a stator having a second axial length, preferably a stator length between 26.5 mm and 34 mm. In other words, the spring elements provided for such a stator are designed with three spring arms.

The spring element group further has third spring elements with four (4) spring arms extending or bent out of a spring main body for a stator having a third axial length, preferably a stator length between 34.5 mm and 42 mm. In other words, the spring elements provided for such a stator are designed with four spring arms.

The spring element group further has fourth spring elements with five (5) spring arms extending or bent out of a spring main body for a stator having a fourth axial length, preferably a stator length between 42.5 mm and 50 mm. In other words, the spring elements provided for such a stator are designed with five spring arms.

The spring element group further has fifth spring elements with six (6) spring arms extending or bent out of a spring main body for a stator having a fourth axial length, preferably a stator length between 50.5 mm and 58 mm. In other words, the spring elements provided for such a stator are designed with six spring arms.

Here and in the following text, a “form fit” or a “form-fitting connection” between at least two parts connected to one another is understood to mean in particular that the cohesion of the parts connected to one another, at least in one direction, here the radial direction based on the central axis of the stator and the axis of rotation of the electric motor, is achieved by contours of the parts themselves interengaging directly. The “blocking” of a mutual movement in this direction, here the radial direction, is therefore carried out as a result of the shape.

The electric motor, which in particular is intended and configured as a steering motor of a motor vehicle, has a motor shaft and a rotor fixed to the shaft, and a stator of this type and a motor housing, in which the stator is arranged with spring elements with an identical number of spring arms, selected from the spring element group and inserted radially with a form fit into the axial slots over the outer circumference.

By means of the spring elements, the stator in the (motor) housing is decoupled in terms of structure-borne sound with, at the same time, a sufficient radial and/or tangential stiffness, by the spring elements inserted axially into the axial slots on the outer circumference and spring elements held radially with a form fit therein. By means of specific adaptation or design of the radial and tangential (spring) stiffness of the spring element used, the requirements on the structure-borne sound, which is generated because of the transmission to the (motor) housing of vibration generated by the stator as a result of the electromagnetic excitation, are met.

The radial and tangential (spring) stiffness of the spring elements used, as is known, depends on the axial slot on the stator side and on the stator weight with a negligible stator diameter. The invention is then based on the consideration that the acoustic behavior of the electric motor can be adjusted or adapted by the number of spring arms, on the one hand, and via the geometry of the spring element, in particular its material thickness (spring thickness) and its spring arm width. As is known, the spring arm width is relevant or decisive for the tangential stiffness, and the material thickness for the radial and tangential stiffness. Preferably, during the selection of the spring parameters, the motor rotational speed should also be taken into account, in particular with regard to the radial and tangential rigid-body movement of the stator.

With the stator according to the invention and by the selection of the spring elements used from the spring element group according to the invention, the acoustic properties of the electric motor in motor operation are improved by virtue of oscillations and/or vibrations of the stator that are produced not being transmitted to the motor housing as structure-borne sound because of the spring elements selected from the (spring element) group. By means of the coupling springs of the spring elements inserted into the axial slots, the stator is supported on a bearing shield of the electric motor, so that decoupling or damping of the stator from and with respect to the bearing shield is also provided.

An exemplary embodiment of the invention is explained in more detail below with reference to a drawing, in which:

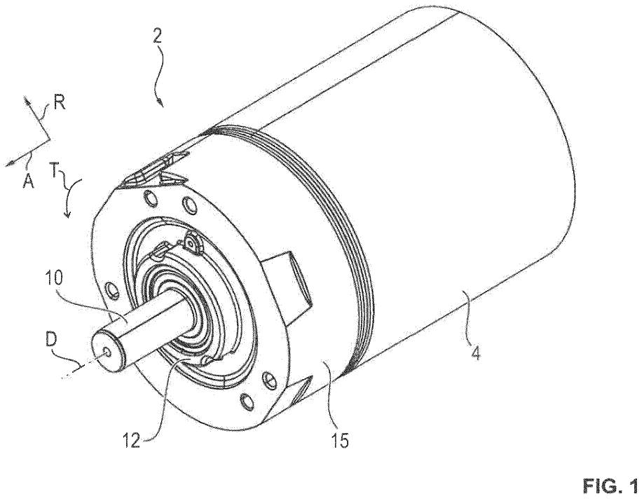

FIG. 1 shows a perspective illustration of an electric motor having a motor housing and a bearing shield,

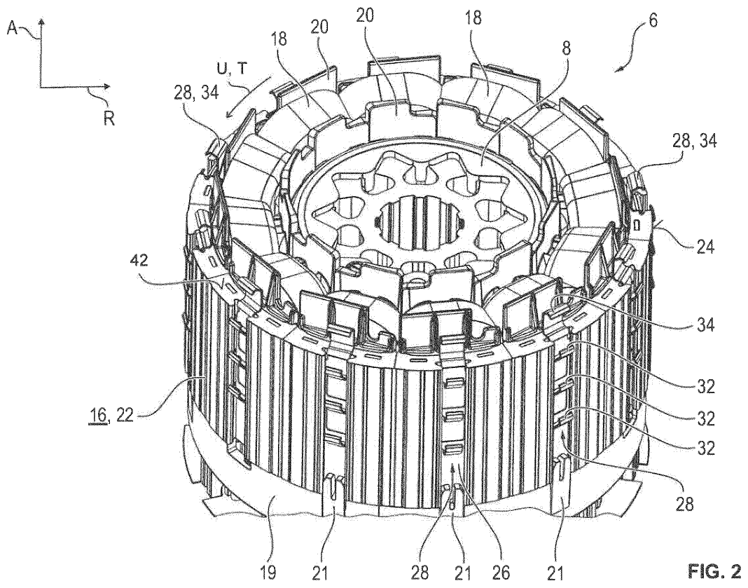

FIG. 2 shows a perspective illustration of a stator with spring elements used on the outer circumference and a rotor of the electric motor,

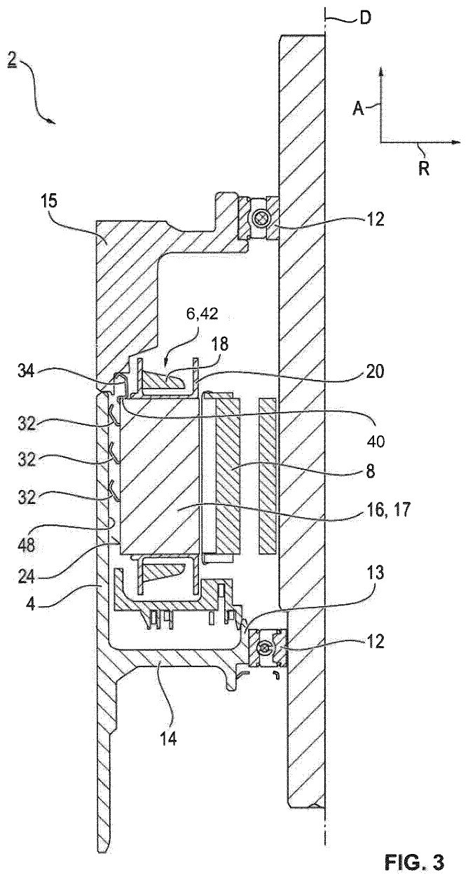

FIG. 3 shows a sectional illustration of the electric motor in a detail,

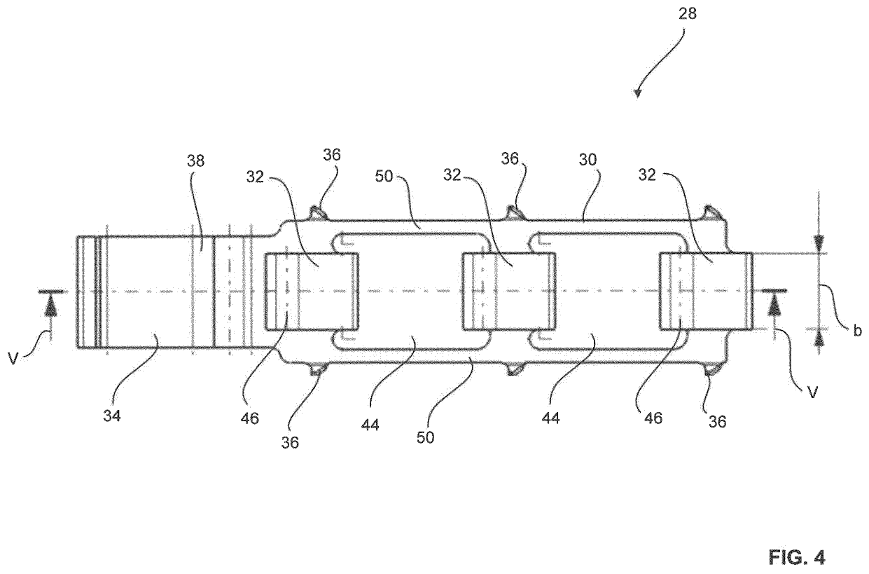

FIG. 4 shows a top view of a spring element with three spring arms, and

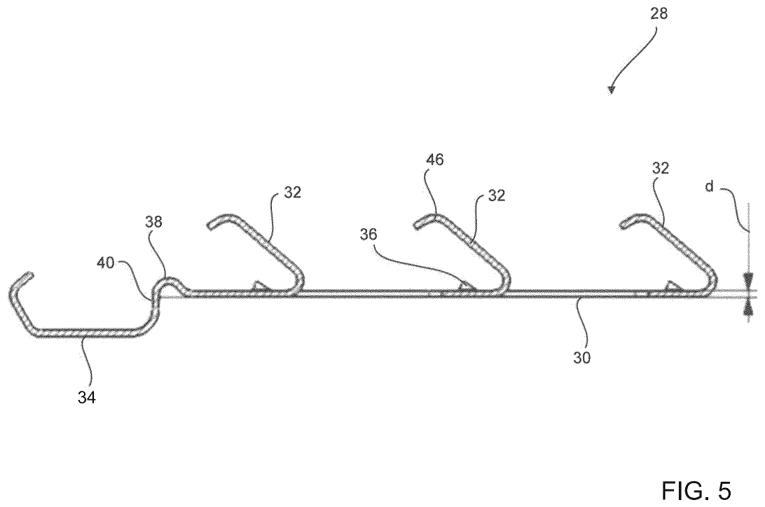

FIG. 5 shows the spring element in a sectional illustration along the line V-V in FIG. 4.

Parts and variables that correspond to one another are provided with the same designations in all the figures.

The electric motor 2 illustrated in FIG. 1 has a motor housing 4 with stator 6 and rotor 8 arranged therein (FIG. 2). In this exemplary embodiment, the electric motor 2 is designed as an internal-rotor motor. The rotor 8 is co-rotationally joined to a motor shaft 10. The motor shaft 10 is rotatably mounted by means of two bearings 12. The bearings 12 are designed, for example, as ball bearings. One of the bearings 12 is arranged in a bearing seat 13 of a housing base 14 of the motor housing 4 that is designed as a (housing) intermediate wall. The other bearing 12 is arranged in a bearing shield 15, which, as a cover, is placed axially on the pot-shaped motor housing 4, on the end face opposite to the housing base 14.

The stator 6 illustrated in more detail in FIGS. 2 and 3 has a stator main body 16. In the exemplary embodiment illustrated, the stator main body 16 is designed with twelve stator teeth 17, which extend in the radial direction R (radially) inward in the direction of the central axis of rotation D illustrated in the drawing. Between the stator teeth 17, clearances, not specifically designated, are formed in which the windings of (stator) coils 18 are accommodated, which are connected to one another by means of an interconnection ring 19 on the end face, for example in a star or delta connection, forming a stator-field or rotational-field winding. Here, the coils 18 are arranged on insulating coil formers 20, which are placed on the stator teeth 17 (FIG. 3). The interconnection ring 19 is placed on the end face of the stator main body 16 and fixed in the axial slots 26 by means of latching tongues 21. The latching tongues 21 act as positioners or centering gages.

The stator main body 16 has a stator yoke 22 or return path, which encloses the stator teeth 17 on the circumference. In the exemplary embodiment, the stator main body 16 is of individual tooth design, in which the stator 6 or its stator main body 16 is assembled from individual stator teeth 17. The stator yoke 22 can also be a separate component, the stator teeth 17 forming a stator star which is inserted into the stator yoke 22. The stator 6 and/or the stator main body 16 or the stator teeth 17 is or are in the form of a solid body or solid bodies, for example, or is or are built up as a laminated core or laminated cores made up of individual laminations.

On the outer circumference 24 of the stator yoke 22, that is to say on the outer circumference, the axial slots 26 running in the axial direction A and extending radially (in the radial direction R) inward toward the axis of rotation D are introduced into the stator main body 16. The respective axial slot 26 is designed, for example, as a dovetail-shaped or T-shaped radial undercut in the outer circumference 24. A spring element 28 is inserted radially with a form fit into the respective axial slots 26.

As can be seen from FIGS. 4 and 5, the spring element 28 has a strip-shaped or plate-shaped spring main body 30, on which three spring arms 32 are formed in the exemplary embodiment. Furthermore, a coupling spring 34 and clamping claws 36 are formed in one piece on both sides of the spring main body 30.

The coupling spring 34 is a resilient (spring) tab bent in an approximately C shape or U shape, and arranged on a narrow side or front face of the substantially rectangular spring main body 30. At the transition between the front face or narrow side of the spring main body 30 to the coupling spring 34, a bending portion 38 that is elevated radially or projects out of the plane of the spring main body 30 is provided, forming a contact edge 40. As can be seen in FIGS. 2 and 3, in the assembled state inserted into the respective axial slot 26, the spring element 28 rests with the contact edge 40 on a front face 42 of the stator main body 16 or its stator yoke 22. In the assembled state of the spring element 28, the coupling spring 34 extends axially beyond the axial slot 6 and beyond the front face 42 of the stator main body 16.

The spring element 28 is designed in particular as a stamped and bent part. The starting material provided is preferably a sheet-metal strip, expediently made of steel, which forms the spring main body 30. The spring arms 32 are punched out of the latter and bent out or up out of the plane of the spring main body 30. In the exemplary embodiment, two of the three spring arms 32 are bent up or out of the spring main body 30, forming window-like recesses or cutouts 44 remaining on the main body. At the free ends, the spring arms 32 are angled over toward the spring main body 30, forming preferably rounded bending edges 46. With these bending edges 46, the spring arms 32 rest quasi-linearly on the (cylindrical) inner wall 48 of the motor housing 4 (FIG. 3). The third spring arm 32 is molded on a narrow side or end face of the spring main body 30 that is opposite the coupling spring 34.

The spring main body 30 projects beyond the spring arms 32 on both sides in the circumferential direction U or in the tangential direction T (FIG. 2) relative to the (motor) axis of rotation D. With this projection 50 on both sides, the spring element 28 engages behind the slot flanks of the axial slot 26, which form an undercut for the radially form-fitting retention of the spring element 28 inserted axially into the axial slot 26. The spring arms 32 are bent up out of the spring main body 30 at an angle of inclination or attack of about 45°. The characteristic of the spring arms 32, and thus the ratio between spring force and spring travel, can be adjusted or predefined via the angle of inclination.

By means of the spring elements 28 inserted with a form fit into the axial slots 26 of the stator 6, the transmission to the motor housing 4 of the structure-borne sound caused by the electromagnetic forces induced by operation is reduced, in that the stator 6 is decoupled from the motor housing 4 and possibly from the bearing shield 15 by means of the spring elements 28. In addition, the stator 6 is rotationally secured in the motor housing 4 by the spring elements 28 resting on the inner wall 48 and possibly on the bearing shield 15.

The radial and tangential (spring) stiffness of the spring elements 28 used is substantially adjusted or predefined as a function of the axial length of the stator 6 (stator length). To this end, the respective spring element 28 is designed with two to six spring arms 28. The material thickness d (FIG. 5) of the spring element 28 or the spring main body 30 (spring element or main body 27 thickness) is between 0.1 mm and 0.5 mm, preferably between 0.15 mm and 0.4 mm. The spring arm width b (FIG. 4) of the respective spring arm 32 of the spring element 28 used is between 1.5 mm and 5 mm, preferably between 2 mm and 4 mm. The ratio of the spring arm width b of the respective spring arm 32 of the spring elements 28 used to the material thickness d of the spring element 28 or the spring main body 30 is preferably between 10 and 13.5.

In practical terms, a spring element group having first spring elements 28 with two spring arms 32 is provided, which is preferably used in a stator 6 having an axial length between 18.5 mm and 26 mm. Second spring elements 28 with three spring arms 32 that are provided are preferably used in a stator 6 having an axial length between 26.5 mm and 34 mm. Third spring elements 28 with four spring arms 32 that are provided are preferably used in a stator 6 having an axial length between 34.5 mm and 42 mm. Fourth spring elements 28 with five spring arms 32 that are provided are preferably used in a stator 6 having an axial length between 42.5 mm and 50 mm. Fifth spring elements 28 with six spring arms 32 that are provided are preferably used in a stator 6 having an axial length between 50.5 mm and 58 mm.

The invention is not restricted to the exemplary embodiment described above. Instead, other points of the invention can also be derived therefrom by those skilled in the art without departing from the subject matter of the invention. In particular, individual features described in connection with the exemplary embodiment can also further be combined with one another in another way without departing from the subject matter.

The electric motor 2 shown in the exemplary embodiment is in particular a steering motor of a motor vehicle. The solution described above can be used not only in the application specifically illustrated but also in a similar embodiment in other motor vehicle applications, such as, for example, in electric brake motors, door and tailgate systems, window lifters, and in electrical drives and their arrangement in the vehicle or in other electric machines and systems.

### LIST OF DESIGNATIONS

2 Electric motor
4 Motor housing
6 Stator
8 Motor
10 Motor shaft
12 Bearing
13 Bearing seat
14 Housing base
15 Bearing shield
16 Stator main body
17 Stator tooth
18 Coil
20 Coil former
21 Latching tongue
22 Stator yoke
24 Outer circumference
26 Axial slot
28 Spring element
30 Spring main body
32 Spring arm
34 Coupling spring
36 Clamping claw
38 Bending portion
40 Contact edge
42 Front face
44 Recess/cutout
46 Bending edge
48 Inner wall
15 Projection
b Spring arm width
d Material thickness
A Axial direction
D Axis of rotation
R Radial direction
T Tangential direction
U Circumferential direction

1-10. (canceled)

11. A stator for an electric motor, comprising:
a cylindrical stator main body having radially inwardly directed stator teeth and a number of axial slots over a circumference thereof;
a number of spring elements, each having a spring main body inserted, or to be inserted, radially with a form fit into a respective said axial slot, and each having spring arms extending or bent out of the spring main body and projecting circumferentially radially beyond said stator main body;
said spring arms of said spring elements having a given spring arm width and said spring elements or said spring main body having a given material thickness;
said number of said spring arms increasing with an increasing axial length of said stator main body; and/or
a ratio of the given spring arm width to the given material thickness of said spring element or said spring main body lying between 10 and 15.

12. The stator according to claim 11, wherein the ratio of the spring arm width to the material thickness lies between 11 and 14.

13. The stator according to claim 12, wherein the ratio of the spring arm width to the material thickness is 13±0.5.

14. The stator (6) according to claim 11, wherein said spring element is a one-piece stamped and bent part.

15. The stator according to claim 11, wherein the given material thickness of said spring element or said spring main body lies between 0.1 mm and 0.5 mm.

16. The stator according to claim 15, wherein the given material thickness lies between 0.15 mm and 0.4 mm.

17. The stator according to claim 11, wherein the given spring arm width of the respective said spring arm lies between 1.5 mm and 5 mm.

18. The stator according to claim 17, wherein the given spring arm width lies between 2 mm and 4 mm.

19. The stator (6) according to claim 11, wherein:
said spring element has two spring arms when said stator main body has a first axial length;
said spring element has four spring arms when said stator main body has a second axial length that is twice the first axial length; or
said spring element has six spring arms when said stator main body has a third axial length that is three times the first axial length.

20. The stator according to claim 11, wherein, when the axial length of the stator main body increases by 11.5±1.5 mm, said number of said spring arms of said spring element increases by one further spring arm.

21. The stator according to claim 11, wherein said spring element comprises a coupling spring formed on a narrow side of said spring main body and configured to project axially out of the respective said axial slot.

22. The stator according to claim 21, wherein said coupling spring adjoins said spring main body via a radially elevated bending portion, which forms a contact edge by way of which said spring element (28) rests on a front face of said stator main body.

23. A spring element group for insertion into an axial slot of a stator, the spring element group comprising:
first spring elements with two spring arms extending or bent out of a spring main body for a stator having a first axial length;
second spring elements with three spring arms extending or bent out of a spring main body for a stator having a second axial length;
third spring elements with four spring arms extending or bent out of a spring main body for a stator having a third axial length;
fourth spring elements with five spring arms extending or bent out of a spring main body for a stator having a fourth axial length;
fifth spring elements with six spring arms extending or bent out of a spring main body for a stator having a fourth axial length.

24. The spring element group according to claim 23, wherein:
the first axial length of the stator is between 18.5 mm and 26 mm;
the second axial length of the stator is between 26.5 mm and 34 mm;
the third axial length of the stator is between 34.5 mm and 42 mm;
the fourth axial length of the stator is between 42.5 mm and 50 mm; and
the fifth axial length of the stator is between 50.5 mm and 58 mm;

25. An electric motor, comprising:
a motor shaft and a rotor fixed to the shaft;
a motor housing; and
a stator according to claim 11 disposed in said motor housing, said stator having the spring elements inserted radially with a form fit into the axial slots of the outer circumference, with said spring elements being selected from a spring element group consisting of:
first spring elements with two spring arms extending or bent out of a spring main body for said stator having a first axial length;
second spring elements with three spring arms extending or bent out of a spring main body for said stator having a second axial length;
third spring elements with four spring arms extending or bent out of a spring main body for said stator having a third axial length;
fourth spring elements with five spring arms extending or bent out of a spring main body for said stator having a fourth axial length; and
fifth spring elements with six spring arms extending or bent out of a spring main body for said stator having a fourth axial length.

26. The electric motor according to claim 25, configured as a steering motor for a motor vehicle.
